(19) United States
(12) Patent Application Publication
(10) Pub. No.: US 2011/0141511 A1
(43) Pub. Date: Jun. 16, 2011

(54) Printer Settings Customization Mechanism

(76) Inventors: John G. Milanski, Louisville, CO (US); Brian W. Moroney, Longmont, CO (US)

(21) Appl. No.: 12/636,127

(22) Filed: Dec. 11, 2009

(51) Int. Cl. G06F 15/00; G06F 3/01

(52) U.S. Cl. 358/1.15; 715/745

(57) ABSTRACT

A method disclosed. The method includes receiving printer settings from a plurality of printers, generating one or more settings profiles based upon the received printer settings; downloading a settings profile to a new printer upon installation; and customizing a graphical user interface (GUI) based upon the downloaded settings profile.

### FIELD OF THE INVENTION

The invention relates to the field of printing systems, and in particular, to customizing printer settings.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer. Once a connection is established between a workstation and the printer, printing software is typically implemented at a print server to manage a print job from job entry and management through the complete printing process.

The jobs that print shops print are very diverse, resulting in very diverse print shops (e.g., commercial printers, service bureaus, in-house data centers, direct mailers, shared print rooms, corporate reprographics, small and large businesses, government agencies) and very diverse printing requirements (e.g., jobs, operators, security, queue setup, network configurations, finishing, mailing, volume, print quality). Of particular importance, some print shops have dedicated printer operators, while many do not.

To serve such a diverse customer base, the printing software is made customizable using thousands of settings within the software. The problem is that the print shop and the maker of the software must spend significant effort customizing these settings for each user. Further, the print shop may not know what type of customization is possible because of the fact that so many settings are available.

Accordingly, an efficient mechanism for customizing printer settings based on a type of print environment and/or type of output produced is desired.

### SUMMARY

In one embodiment, a method includes receiving printer settings from a plurality of printers, generating one or more settings profiles based upon the received printer settings; downloading a settings profile to a new printer upon installation; and customizing a graphical user interface (GUI) based upon the downloaded settings profile.

Another embodiment discloses a system including two or more printers, a network coupled to the printers and a profile server coupled to the network. The profile server receives printer settings from the printers, generates one or more settings profiles based upon the received printer settings, downloads a settings profile to a new installed printer and customizes a graphical user interface (GUI) based upon the downloaded settings profile.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of a network;

FIG. 3 is a flow diagram illustrating one embodiment of customizing printer settings; and

FIG. 4 illustrates one embodiment of a computer system.

### DETAILED DESCRIPTION

A printer settings customization mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

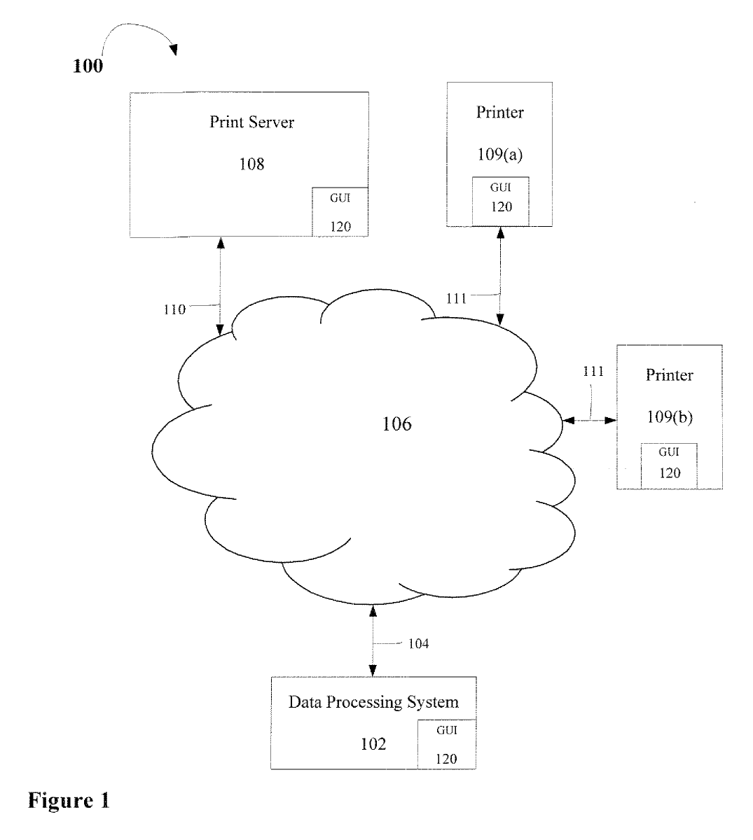

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, the operating system on data processing system 102 allows a user to select the desired print server 108 and submit requests for service requests to printer 109 via print server 108 over network 106. In a further embodiment, print server 108 includes a print queue for print jobs requested by remote data processing systems.

Although described as separate entities, other embodiments may include print server 108 being incorporated in one or more of the printers 109. However in other embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 between data processing system 102 and one or more of printers 109. In other embodiments, the printing software product manages printing of documents from multiple data processing systems 102 to the one or more printers 109.

According to one embodiment, the printing software product may be implemented using either InfoPrint Manager (IPM) or InfoPrint ProcessDirector (IPPD), although other types of printing software may be used instead. In a further embodiment, data processing system 102 includes a print application that interacts with the printing software product at printer server 108 to provide for efficient transmission of print jobs.

In one embodiment, the printing software product includes a graphical user interface (GUI) 120 that enables a system administrator (or operator) to interact with the printing software product and print application. In such an embodiment, GUI 120 includes printer settings that enable an operator (or user) to select various print options to employ at printer 109. As shown in FIG. 1, GUI 120 may be accessed at data processing system 102 and/or a printer 109.

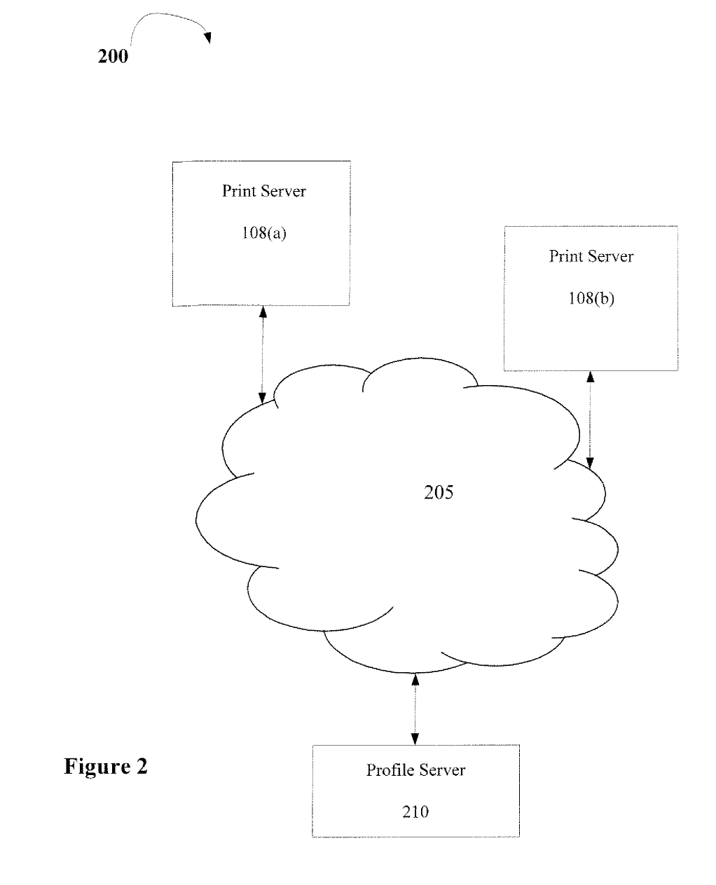

According to one embodiment, the settings are kept in a file stored at print server 108 and/or printer 109. In a further embodiment, the stored settings are accessed by a server operated by the printer 109, where the settings are subsequently used to assist in generating various settings profiles. FIG. 2 illustrates one embodiment of a settings profile network 200.

Network 200 includes a profile server 210 and printer servers 108 from various data processing system networks 100 coupled via a network 205. According to one embodiment, profile server 210 accesses printer settings and printing jobs stored at each printer server 108 and analyzes the settings and jobs to generate one or more settings profiles that cover all printer settings on a printer (e.g., 2000+) for each major type of printing user. The settings profiles are subsequently implemented to customize profiles for newly installed printers 109.

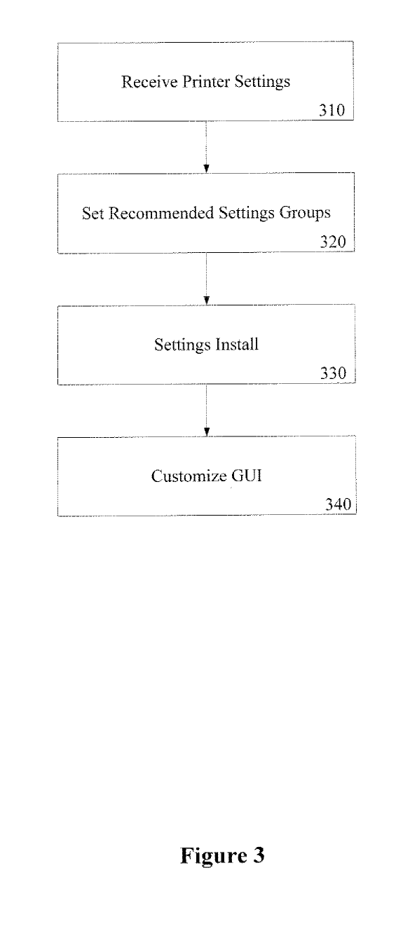

FIG. 3 is a flow diagram illustrating one embodiment of customizing printer settings. At processing block 310, profile server 210 receives printer settings from one or more printer servers 108. According to one embodiment, a printer server 108 will transmit the stored printer setting file to profile server 210 whenever a setting is changed for a printer 109. However in other embodiments, a service technician may be alerted to download the printer setting file to profile server 210.

In a further embodiment, profile server 210 may subsequently analyze the file to determine if the current settings profile for the printer 109 should be changed, if the printer 109 should be using a different settings profile, or if a new settings profile needs to be created. Thus, knowing what settings are being changed assists in determining the printer features being used, and what features should be emphasized in future printer 109 releases.

At processing block 320, aggregates and analyzes the printer setting files received from the various printer servers 108 in network 200 in order to generate recommended profile groups. In one embodiment, the settings profiles are generated by finding common features in the different printer setting files. Subsequently, settings profile groups are established for each major type of printing user (e.g., commercial printers, service bureaus, in-house data centers, etc.).

One embodiment of exemplary usage of customizing printer settings may involve printer 109 being used in both office and commercial environments, where in an office environment an operator setting up printer 109 may wish to limit users from changing tray settings, while this functionality is required in a commercial print environment. Instead of requiring a setup operator to know where to find a tray setting, the operator may select a higher level environment setting like “Use In Office Environment” that would select the proper settings or automatically determine the proper settings based settings of other devices on the network.

In further embodiments, the settings profiles are dynamically adjusted as more data is collected from printer setting files. In still further embodiments, the ability to gather printer settings may also feed into other systems, such as productivity tracking (PT) applications, which provides reports on printer usage and operator performance.

At processing block 330, settings profile is downloaded via a server 108 upon installation of a new printer 109. According to one embodiment, an operator is prompted via GUI 120 to answer questions regarding how the printer will be used. The questions may include, for example, how many different types of paper do you use, do you hold jobs at the printer, how important is keeping job data secure, how experienced are your printer operators, are most jobs stapled, etc.

In one embodiment, the answers to these questions will classify the user (e.g. corporate reproduction, direct mailer, service bureau), and printer 109 will select a settings profile based on the classification and set the printer defaults appropriately. For example, for a printer used in a production facility print, save and hold queues would be created, but for a shared print room printer no queues would be created.

At processing block 340, GUI 120 is customized based on the selected profile. As a result, more important functions are moved to the main screen of GUI 120, while less important functions are moved to lower screens.

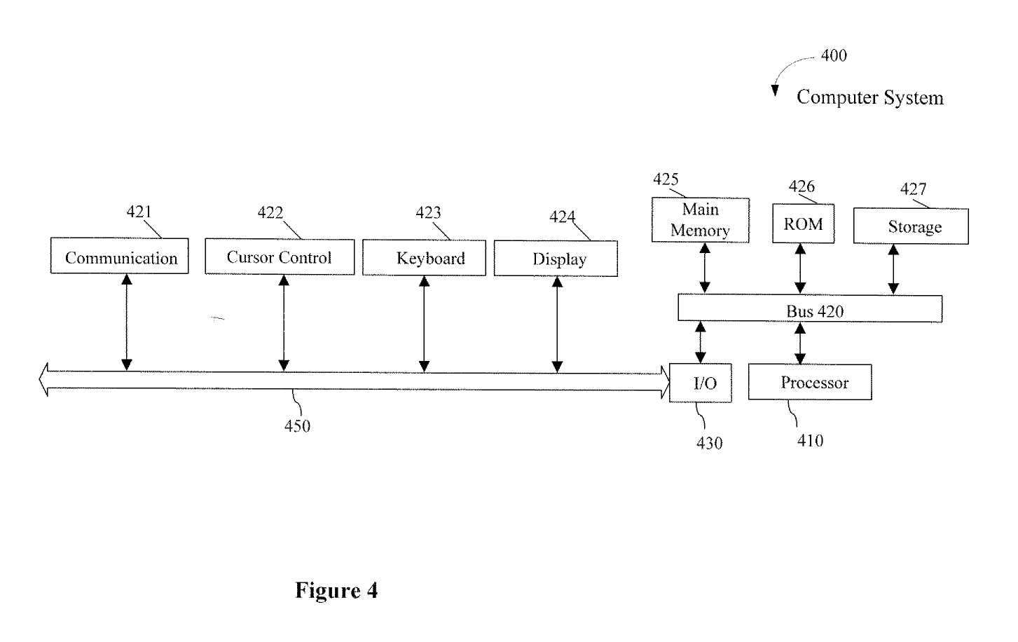

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The above-described mechanism uses prebuilt profiles to reduce the time and expense needed to customize thousands of settings for each printer consumer. Additionally, the mechanism provides a better user experience since desired features are easier to find on the main screen of the GUI, while unneeded features are hidden.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
receiving printer settings from a plurality of printers;
generating one or more settings profiles based upon the received printer settings;
downloading a settings profile to a new printer upon installation; and
customizing a graphical user interface (GUI) based upon the downloaded settings profile.

2. The method of claim 1 wherein a printer settings file is received whenever a setting is changed at one of the plurality of printers.

3. The method of claim 1 wherein the settings profiles are generated by finding commonality in the printer settings received from the plurality of printers.

4. The method of claim 3 wherein each settings profile is dynamically adjusted as additional printer settings are received.

5. The method of claim 1 wherein downloading a settings profile to the new printer comprises:
prompting questions regarding how the printer will be used;
classifying the printer user based upon answers to the questions; and
selecting a settings profile associated with the classification.

6. The method of claim 5 further comprising setting defaults at the printer based upon the selected settings profile.

7. The method of claim 1 wherein customizing the GUI comprises moving important functions associated with the selected settings profile to a main screen of the GUI.

8. The method of claim 7 wherein customizing the GUI further comprises moving less important functions associated with the selected settings profile to a secondary screen of the GUI.

9. The method of claim 2 wherein the printer settings file is analyzed to determine whether a current settings profile for the printer should be changed to a different settings profile.

10. A system comprising:
two or more printers;
a network coupled to the printers; and
a profile server, coupled to the network, to receive printer settings from the printers, generate one or more settings profiles based upon the received printer settings, download a settings profile to a new installed printer and customize a graphical user interface (GUI) based upon the downloaded settings profile.

11. The system of claim 10 wherein the profile server receives a printer settings file from a printer whenever a setting is changed at one of the plurality of printers.

12. The system of claim 11 wherein the profile server analyzes the printer settings file to determine whether a current settings profile for the printer should be changed to a different settings profile.

13. The system of claim 10 wherein the profile server generates the settings profiles by finding commonality the in the printer settings received from the plurality of printers.

14. The system of claim 13 wherein each settings profile is dynamically adjusted as additional printer settings are received.

15. The system of claim 10 wherein the profile server downloads a settings profile to the new printer by prompting questions regarding how the printer will be used, classifying the printer user based upon answers to the questions and selecting a settings profile associated with the classification.

16. The system of claim 10 wherein the profile server customizes the GUI by moving important functions associated with the selected settings profile to a main screen of the GUI and moving less important functions associated with the selected settings profile to a lower screen of the GUI.

17. An article of manufacture comprising a machine-readable medium including data that, when accessed by a machine, cause the machine to perform operations comprising:
receiving printer settings from a plurality of printers;
generating one or more settings profiles based upon the received printer settings;
downloading a settings profile to a new printer upon installation; and
customizing a graphical user interface (GUI) based upon the downloaded settings profile.

18. The article of manufacture of claim 17 wherein the settings profiles are generated by finding commonality the in the printer settings received from the plurality of printers.

19. The article of manufacture of claim 17 wherein downloading a settings profile to the new printer comprises:
prompting questions regarding how the printer will be used;
classifying the printer user based upon answers to the questions; and
selecting a settings profile associated with the classification.

20. The article of manufacture of claim 17 wherein customizing the GUI comprises moving important functions associated with the selected settings profile to a main screen of the GUI.
